(19) United States
(12) Patent Application Publication
(10) Pub. No.: US 2008/0142582 A1
(43) Pub. Date: Jun. 19, 2008

(54) Electronic System and Method for Recharging Credit Cards

(76) Inventor: Fabio Giovanni Attilio Corioni, Brescia (IT)

Correspondence Address: HEDMAN & COSTIGAN P.C., 1185 AVENUE OF THE AMERICAS, NEW YORK, NY, 10036, US

(21) Appl. No.: 11/883,203

(22) PCT Filed: Feb. 7, 2006
(86) PCT No.: PCT/EP2006/001201

§ 371 Date: Nov. 7, 2007

(30) Foreign Application Priority Data
Feb. 9, 2005 (IT) MI2005 A 000178

(51) Int. Cl. G06Q 40/00; G06Q 90/00

(52) U.S. Cl. 235/379; 705/41

(57) ABSTRACT

An electronic system for recharging prepaid credit/payment cards active on a telecommunication network for electronic bank transactions which comprises a central processing unit (2), a series of electronic terminals (3) in which a user can effect a bank transaction connected to said central processing unit by means of a communication channel (4).

The present invention relates to an electronic system and method for recharging credit/payment cards or electronic purses or debit cards.

In particular, the present invention relates to an electronic system and method for recharging credit cards, of the prepaid and possibly anonymous type.

So-called prepaid credit cards, i.e. credit cards issued by banks and which can also be purchased anonymously from the counters of said banks by cash payment, are known in the state of the art. These credit cards have a prefixed credit and can be used either in the form of a credit card, for example also for purchases via Internet, or in the form of a cashomat for withdrawing cash and for payment by means of the known POS terminals.

Telephone cards or telephone codes (PIN) issued by all known fixed or mobile phone operators, which can be purchased with cash and with which it is possible to recharge telephone credits of mobile phones, are also known.

The Applicant has established the objective of allowing a prepaid credit card to be recharged in a simple and reliable way, by means of a simple telephone or telematic operation.

For this purpose, the Applicant has found that an extremely simple way of recharging these cards can be effected analogously to a telephone recharge, for example by using a prepaid recharge telephone card.

An aspect of the present invention relates to an electronic system for recharging prepaid credit cards active on a telecommunication network for electronic bank transactions which comprises a central processing unit, a series of electronic terminals in which a user can effect a bank transaction connected to said central processing unit by means of a communication channel, characterized in that it comprises an electronic recharge unit connected to said central processing unit, which is capable of transferring the credit contained in a telephone card onto the credit of said prepaid credit card.

A further aspect of the present invention relates to a method for recharging a prepaid credit card active on a telecommunication network for electronic bank transactions which comprises a central processing unit, a series of electronic terminals in which a user can effect a bank transaction, connected to said central processing unit by means of a communication channel, characterized in that said method comprises the following phases:
receiving a recharge request of said prepaid credit card, for a pre-established quantity of money, on the part of a user, by means of an electronic telephone recharge managing unit associated with a recharge telephone service,
identifying the authenticity of said request,
sending to said central processing unit, an updating request of the residual credit corresponding to said pre-established quantity of money.

The characteristics and advantages of the system according to the present invention will appear more evident from the following illustrative and non-limiting description of an embodiment with reference to the enclosed FIGURE, in which:

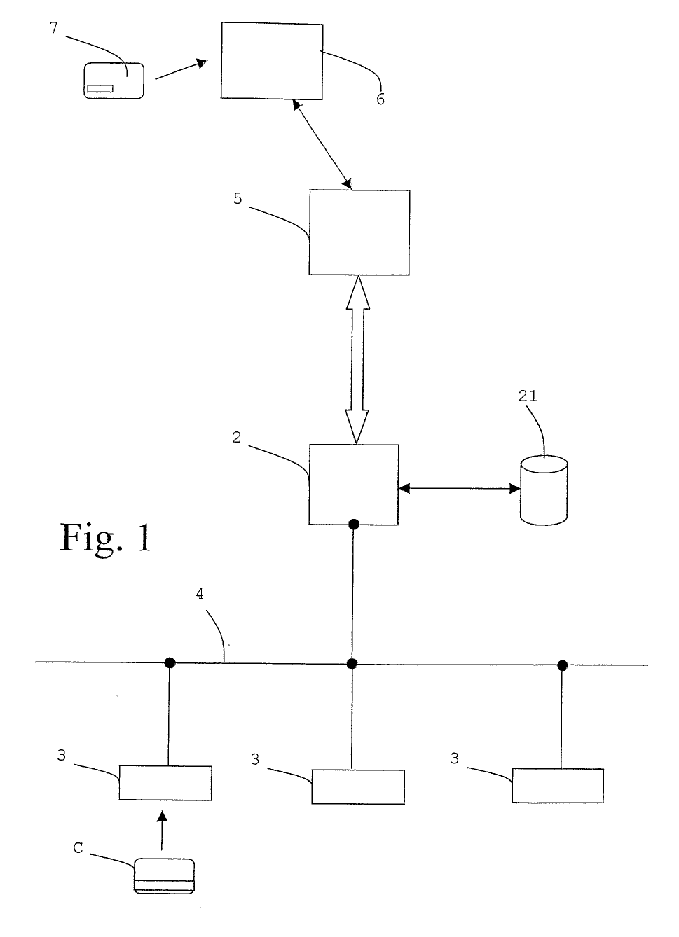

FIG. 1 is a scheme of a telecommunication network for electronic bank transactions with which the system according to the present invention is associated.

With reference to the above FIGURE, a telecommunication network for electronic bank transactions comprises a central processing unit 2, a series of electronic terminals 3 wherein a user can effect a bank transaction connected to said central processing unit by means of a communication channel 4.

Said electronic terminals are terminals directly or indirectly connected to said telecommunication network for bank transactions, for example by means of a fixed line or wireless system. Indirect connection means that this can be effected by at least one interface with said telecommunication network. Examples of direct connection electronic terminals are a cash dispenser window, a POS terminal for payment by means of a CASHOMAT card or credit card, terminals for effecting international electronic bank transactions.

Examples of indirect connections are a mobile phone or fixed telephone, for example activated by means of telephone cards.

A user with a prepaid credit card C, i.e. a credit card issued by a bank having a prefixed credit, can use it in any of said electronic terminals 3 for effecting a payment or withdrawing cash, up to the prefixed credit limit.

Said central unit 2 is equipped with a data base of operations 21 in which the bank transactions electronically effected by each prepaid card are memorized.

According to the present invention, by associating an electronic recharge unit 5 which communicates with said central unit 2, with the bank telecommunication network described above, it is possible to recharge the credit of said prepaid credit cards C with a prefixed quantity. Said electronic recharge unit 5 is a unit which interacts with an electronic telephone recharge management unit 6, of the type substantially known associated with prepaid telephone cards 7, which can be purchased in numerous sales points.

The recharge operation of the prepaid credit card consists in purchasing one of said prepaid telephone cards or PIN codes 7 and following a guided procedure completely similar to that for recharging a mobile phone.

For example, a telephone call can be made or telephone or telematic contact can be made with the telephone number of the recharge service indicated on the prepaid telephone card to communicate the series number of the prepaid credit card and secret code indicated on the telephone card purchased. As the recharge service is in contact with said electronic telephone recharge management unit 6 which, in turn, is associated with said electronic recharge unit 5, it effects the updating of the credit of the prepaid credit card C of the quantity corresponding to the price of the telephone card purchased plus any possible commission for the operation, on the bank circuit, in particular in the central unit 2.

In particular, the recharge service is effected in the following way.

The electronic recharge unit 5 receives a recharge request of said prepaid credit card, for a prefixed quantity of money, from a user by means of the electronic telephone recharge management unit.

The authenticity of the request is then verified and an updating request of the residual credit corresponding to said prefixed quantity of money is sent to said central processing unit.

The authenticity of the request is effected by verifying at least one secret code sent by the user.

The number of times a credit card can be recharged can vary according to the formulations required by the bank issuing the card and the recharge system manager.

1. An electronic system for recharging prepaid credit cards active on a telecommunication network for electronic bank transactions which comprises a central processing unit (2), a series of electronic terminals (3) wherein a user can effect a bank transaction connected to said central processing unit by means of a communication channel (4), characterized in that it comprises an electronic recharge unit (5) connected to said central processing unit (2), which is capable of transferring the credit contained in a telephone card (7) onto the credit of said prepaid credit card (C).

2. The system according to claim 1, wherein said electronic recharge unit communicates with an electronic telephone recharge management unit (6) associated with a recharge telephone service which receives the recharge request of the prepaid credit card from a user who has purchased the telephone card.

3. The system according to claim 1, wherein said electronic terminal is a cash dispenser window ATM for withdrawing cash or a POS terminal for payment by means of a CASHOMAT card or credit card or a terminal for effecting international electronic bank transactions.

4. A method for recharging a prepaid credit card active on a telecommunication network for electronic bank transactions which comprises a central processing unit (2), a series of electronic terminals (3) wherein a user can effect a bank transaction connected to said central processing unit by means of a communication channel (4), characterized in that said method comprises the following phases:
receiving a recharge request of said prepaid credit card (C), for a pre-established quantity of money, from a user, by means of an electronic telephone recharge managing unit (6) associated with a recharge telephone service,
identifying the authenticity of said request,
sending an updating request of the residual credit corresponding to said pre-established quantity of money, to said central processing unit (2).

5. The method according to claim 4, wherein said phase for identifying the authenticity of the request comprises a verification phase of at least one secret code sent by the user.
